(19) United States
(12) Patent Application Publication
(10) Pub. No.: US 2015/0359061 A1
(43) Pub. Date: Dec. 10, 2015

(54) LIGHTING CONTROL TECHNOLOGY AND SYSTEMS AND METHODS USING THE SAME

(71) Applicant: Helmar Adler, Danvers, MA (US)

(72) Inventor: Helmar Adler, Danvers, MA (US)

(73) Assignee: OSRAM SYLVANIA INC., Danvers, MA (US)

(21) Appl. No.: 14/297,096

(22) Filed: Jun. 5, 2014

(51) Int. Cl. H05B 33/08; H05B 37/02

(52) U.S. Cl. CPC H05B 33/0848; H05B 33/0869; H05B 33/086; H05B 37/0281

(57) ABSTRACT

Technologies for controlling light sources and systems and methods using the same are disclosed. In some embodiments, the technologies include a controller that is configured to independently control the intensity and/or color temperature of two light sources to achieve a target lighting characteristic, such as a target color temperature. Independent control over the intensity and/or color temperature of the lighting sources may depend at least in part on a time component, such as time of day or a time step correlating to a time of day. In some embodiments, the controllers are configured to employ one or more time dependent representations of lighting characteristics to determine parameters for independently controlling multiple light sources. The technologies may be used to achieve target lighting characteristics such as a target color temperature, even if two single mode sources are employed.

### FIELD

The present disclosure relates to technology for controlling light sources and, more particularly, to technology for controlling multiple light sources to produce a combined light output with one or more desired lighting characteristics.

### BRIEF DESCRIPTION OF THE DRAWINGS

FIG. 1A is a block diagram of an exemplary lighting system consistent with the present disclosure.

FIG. 1B is a block diagram of another exemplary lighting system consistent with the present disclosure.

FIG. 2A is a block diagram of an exemplary lighting system including an ambient sensor consistent with the present disclosure.

FIG. 2B is a block diagram of another exemplary lighting system including an ambient sensor consistent with the present disclosure.

FIG. 3 is an exemplary system level diagram of a controller consistent with one embodiment of the present disclosure.

FIG. 4 is a plot of correlated color temperature and intensity versus time, consistent with an embodiment of the present disclosure.

FIG. 5A is a plot of correlated color temperature normalized to time steps, consistent with an embodiment of the present disclosure.

FIG. 5B is a plot of intensity normalized to time steps, consistent with an embodiment of the present disclosure.

FIG. 6 is a flow chart of an exemplary method consistent with the present disclosure.

FIG. 7 plots correlated color temperature and lumen values as a function of the dimming value of two different light sources, consistent with an embodiment of the present disclosure.

### DETAILED DESCRIPTION

As used herein, the term “color” is used interchangeably with the term “spectrum.” However, the term, “color” generally is used to refer to a property of radiation that is perceivable by an observer (though this usage is not intended to limit the scope of this term). Accordingly, the term “different colors” implies two different spectra with different wavelength components and/or bandwidths. In addition, “color” may be used to refer to white and non-white light.

For the purpose of this disclosure, the terms “correlated color temperature and “color temperature” are interchangeably used herein to refer to a particular color content or shade (reddish, bluish, etc.) of white light. The color temperature of a radiation sample is conventionally characterized according to the temperature in degrees Kelvin (K) of a black body radiator that radiates essentially the same spectrum as the radiation under examination. Daylight typically has a color temperature ranging from about 700K to over 10,000K, with lower color temperature corresponding to light having a more significant red component, and higher temperature corresponding to light having a more significant blue component. For reference, early morning light can exhibit a color temperature around 3,000K, whereas overcast skies can exhibit a color temperature of around 10,000K.

From time to time, the present disclosure may utilize numerical identifiers such as first, second, etc., in conjunction with one or more features, such as color, color temperature, intensity, etc. Unless otherwise expressly stated, the use of such terms is to attribute the associated characteristic with a particular light source. Thus, “first color temperature” and “first intensity” refer to the color temperature and intensity, respectively, of the light output from a first light source. In contrast, “second color temperature” and “second intensity” refer to the color temperature and intensity, respectively, of the light output of a second light source.

The term “combined light output” is used herein to refer to the light output from a lighting system consistent with the present disclosure. More particularly, the phrase generally refers to the aggregate (mixed) light output from light sources in a lighting system. For example, the combined light output from a lighting system including first and second light sources refers to the combination of the light output from both the first and second light sources. While combined light output may refer to light that is emitted from a lighting system downstream of some optical component such as a mixing chamber, reflector, lens, diffuser, combinations thereof, and the like, use of such components is not required.

The terms, “light emitting diode” and “LED” are used interchangeably herein to refer to any light emitting diode or other type of carrier injection/junction-based system that is capable of generating radiation in response to an electrical signal. Thus, the term LED includes but is not limited to various semiconductor-based structures that emit light in response to current, light emitting polymers, light emitting stripes, electro-luminescent strips, and the like. In particular, the term LED refers to light emitting diodes of all types (including semi-conductor and organic light emitting diodes), and which may be configured to generate light in all or various portions of one or more of the visible, ultraviolet, and UV spectrum. Non-limiting examples of suitable LEDS that may be used include various types of infrared LEDS, ultraviolet LEDS, red LEDS, green LEDS, blue LEDS, yellow LEDS, amber LEDS, orange LEDS, combinations thereof, and the like. Such LEDS may be configured to emit light over a broad spectrum (e.g., the entire visible light spectrum) or a narrow spectrum, either alone or when used in combination with one or more wavelength converting materials. In some embodiments, one or more LEDs is/are used to produce white light.

As used in any embodiment herein, the term “module” may refer to software, firmware, circuitry and combinations thereof, which are configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more lighting controllers, as such as the controllers discussed herein.

The phrase “single mode” when used in conjunction with a light source refers to any of the wide range of light sources that exhibit a single color and color temperature. Such sources include, but are not limited to, conventional incandescent, fluorescent, and high intensity discharge sources (e.g., lamps), as well as single mode LED sources (e.g., high intensity white LEDS that do not have an adjustable or selectable color and color temperature). In contrast, the term “multimode” refers to any of a variety of light sources having at least two selectable colors and/or color temperatures. Such sources include, but are not limited to LED-based light sources as described herein, incandescent sources (e.g., filament lamps, halogen lamps) with multiple selectable colors and/or color temperatures, fluorescent sources with multiple selectable colors and/or color temperatures (e.g., fluorescent lamps with two or more color temperatures), and high intensity discharge sources (e.g., sodium, mercury, and metal halide lamps) with multiple selectable colors and/or color temperatures. In some embodiments, the multimode light sources used herein are capable of exhibiting a wide range of colors and color temperatures, such as the colors in the red, green, blue (RGB) gamut and/or the red, green, blue, and yellow (RGBY) gamut.

The single and multimode light sources described herein may be capable of emitting light over a wide range of intensity (brightness) values. In some embodiments, the single mode sources and multimode sources used in the lighting systems described herein may individually or collectively emit light at an intensity of up to about 25,000 lux or more, where 1 lux=1 lumen per square meter. For example, such sources may individually or collectively emit light at an intensity ranging from greater that 0 to about 25,000 lux, such as about 1000 to about 20,000 lux, about 2500 to about 15000 lux, about 5000 to about 12500 lux, or even from about 8000 to about 12000 lux. In some the artificial light sources used in the present disclosure exhibit an intensity approximating that of natural light supplied by at least one solar-tube. In additional embodiments, the intensity of the single and multimode artificial light sources can be actively changed, e.g., via dimming.

LED light sources described herein may be formed by one or a plurality of individual LEDS. For example, the LED light source may be configured to include a number of individual LEDS that emit different spectra but which, collectively, emit light that is of a desired color (e.g., white, red, blue, green, yellow, orange, amber, etc.) and/or color temperature. An LED may also be associated with one or more phosphors that are an integral part of the LED. The LED light sources may be configured as a single or multimode light source. In any case, the intensity of such sources may be varied by any suitable mechanism, such as a suitable LED driver.

Reference will now be made in detail to exemplary embodiments of the disclosure, examples of which are illustrated in the accompanying drawings. Wherever possible, the same reference numbers will be used throughout the drawings to refer to the same or like parts.

The use and provision of daylight (daylighting) is becoming of increasing interest to architects and building engineers. Daylight can enhance the appearance of interior spaces, and can provide building occupants with social and psychological benefits. In addition, daylight can be used as a substitute or supplement to artificial lighting, which may reduce the overall energy usage of a building and impart substantial savings to building owners/occupants.

Traditionally, windows have been used as the primary mechanism for admitting daylight to the interior of a building. While windows can admit a great deal of light into an interior space, their usefulness for daylighting is limited by several factors. For example, windows can cause substantial solar heating of building interior spaces, particularly when used in large numbers. This can cause discomfort to building occupants, and may increase the load on air conditioning systems used to control the temperature of interior spaces in the building. Windows may also not be sufficient to enable natural light to penetrate to all interior spaces of a building.

Research has therefore investigated other methods and devices for providing natural light to interior spaces. One product resulting from such research is the so-called “solar tube”, also known as a “light tube.” In general, a solar tube includes a light inlet (e.g., a dome) and a diffuser, which are coupled to one another via an optical conduit. Daylight entering the light inlet is passed to the optical conduit, which includes highly reflective surfaces that ultimately deliver the light to the diffuser and, ultimately, to the space to be illuminated. While solar tubes are effective at bringing natural light into interior spaces, their performance is affected by environmental factors such as the position of the sun, cloud cover, etc. They are also generally incapable of providing evening illumination.

Combined lighting systems that combine a source of natural light with a source of artificial light have also been developed. Such systems generally utilize artificial lighting to supplement the natural light provided by the source of natural light, and to provide evening illumination. Although such systems are effective in some circumstances, they often rely on the mixing of natural light and artificial light from different sources. For example, a combined lighting system may mix natural light from a solar tube and a nearby artificial light source. Because artificial light sources typically have a single color and color temperature that is different from the color and color temperature of natural light, users may perceive an undesirable color difference in the natural and artificial light provided by a combined lighting system. This color difference may be exacerbated during parts of the day, as the color temperature and intensity of the natural light provided by the solar-tube changes dynamically, e.g., with the position of the sun.

Because typical combined lighting systems utilize artificial lighting that has a single fixed color and color temperature, such systems are generally incapable of addressing the aforementioned color difference, even if they are equipped with drivers that adjust the intensity of the artificial lighting. With this in mind, the inventor has developed combined lighting system technologies that combine a source of natural light (e.g., a solar tube) with at least one artificial light source that is capable of producing light of varying intensity and/or color temperature. Examples of such technology are described in U.S. patent application Ser. No. 13/152,872 and International Patent Application No. PCT/US2012/036888, the entire contents of which are incorporated herein by reference.

Although combined lighting systems are useful, they often rely on complex control schemes that may be difficult to implement and/or expensive to design. Simplification of the control schemes for such systems is therefore desired. Moreover, simplified control schemes to control the correlated color temperature (CCT) of combined light produced by multiple light sources may also be desired, even independent of the natural light sources that may be employed in an combined lighting system. The technologies described herein aim to address one or more of these needs.

With the foregoing in mind, the present disclosure generally relates to technologies for controlling artificial light sources. As will be described in detail below, the technologies described herein include at least one lighting controller (controller) that functions to control at least a first light source and a second light source, either or both of which may be a single mode or a multimode light source. In some embodiments, the controller may function to provide control parameters such as color (e.g., correlated color temperature) and intensity values to the first and second light sources. The control parameters may be determined by the controller based at least in part on a time component, such as a time of day or a time step correlated to a time of day. Through the use of such control parameters, the controllers described herein may independently control the intensity and/or color temperature of the light output of the first and second light sources, respectively.

By independently controlling the intensity and/or color temperature of the light output from the first and second light sources relative to one another, the controller may cause such sources to produce a combined light output having a desired lighting characteristic. For example and as will be described in detail later, the controller may cause the first and second light sources to collectively produce a combined light output, wherein the combined light output from such sources has a target color temperature C3 that is greater than or equal to the color temperature C1 of the light output from the first light source, and less than or equal to the color temperature C2 of the light output from the second light source, i.e., where C1≦C3≦C2. As will be described later, the controllers described herein may be used to this effect, even when some or all of the light sources employed are single mode sources.

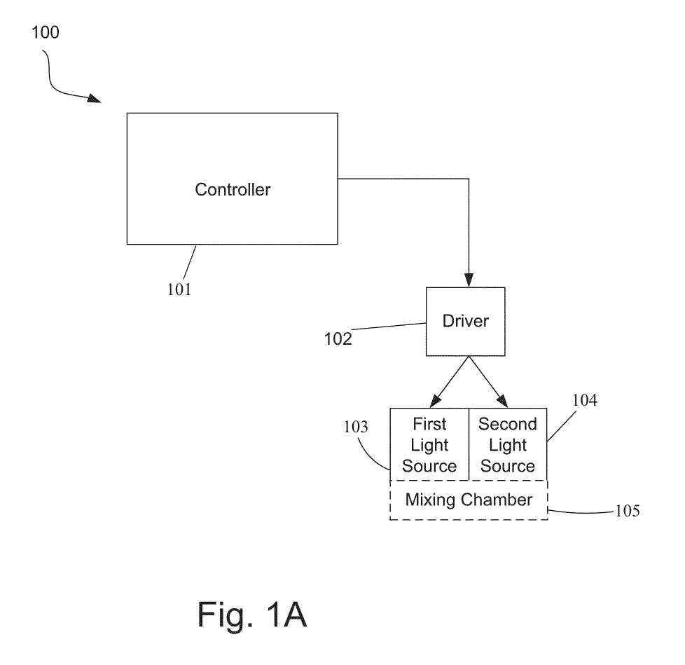

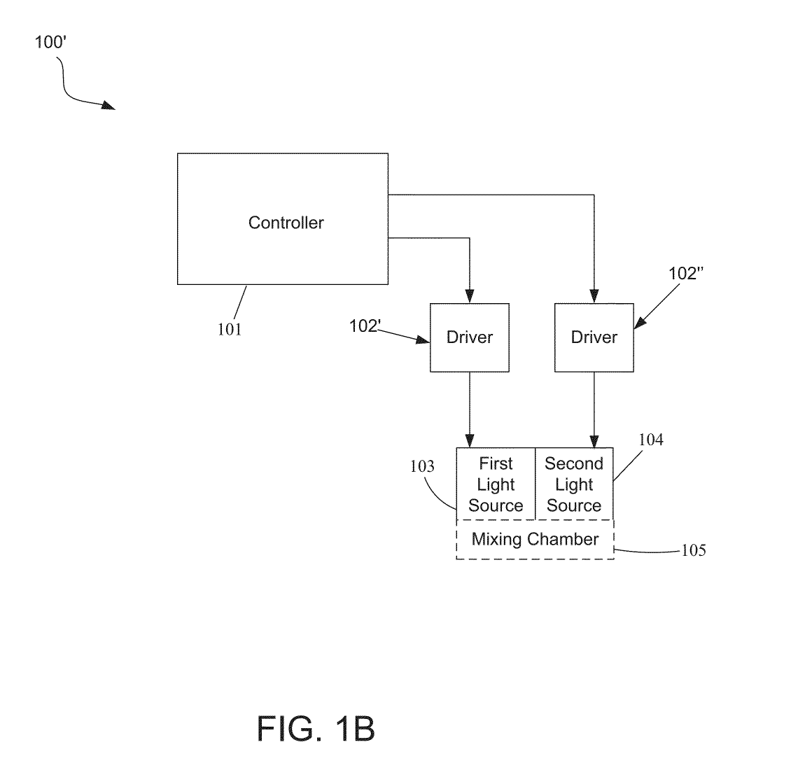

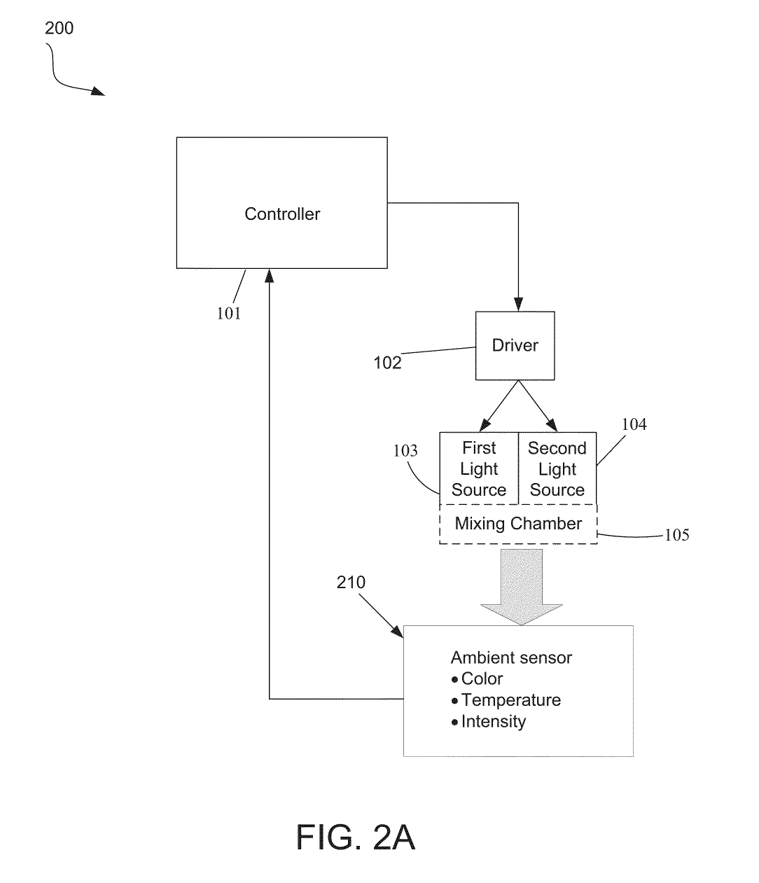

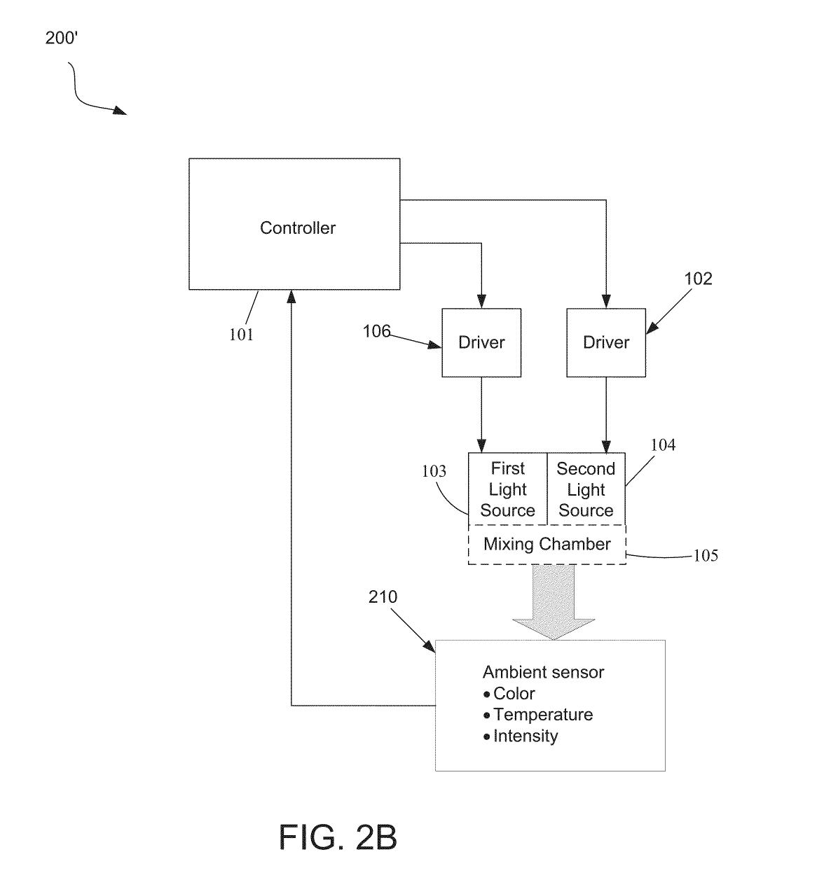

Reference is now made to FIGS. 1A-2B, which depict exemplary lighting systems consistent with the present disclosure. While those FIGS. depict systems that include two light sources, it should be understood that the illustrated configurations are exemplary only and that the present disclosure is not limited to lighting systems wherein two light sources are used. Indeed, the lighting systems described herein may include any number of artificial light sources, such as about 2, 5, 10, 20, 25, 50, or even 100 light sources or more, wherein any number of such sources are single or multimode light sources that are driven by one or more drivers. Lighting systems of significantly greater complexity than those shown in the figures are thus contemplated by the present disclosure.

Similarly, while certain figures illustrate systems wherein two light sources are positioned proximate to one another (e.g., in the same lighting unit), such configuration is not required. It should also be understood that the present disclosure is not limited to systems in which a single controller is used to control multiple light sources, as shown in various FIGS. Indeed, the operations of the controllers described herein may be implemented in whole or in part by a plurality of controllers, which may work in concert to produce a combined light output with desired lighting characteristics such as color temperature. Similarly, while certain figures illustrate systems wherein two light sources are positioned proximate to one another (e.g., in the same luminaire), such configuration is not required.

FIG. 1A depicts an exemplary lighting system 100 consistent with the present disclosure. As shown, system 100 includes controller 101, driver 102, first light source 103, second light source 104, and optional mixing chamber 105. The optional nature of mixing chamber 105 and other optional elements of the present disclosure are depicted in the FIGS. by hashed lines. Of course, the technologies of the present disclosure are not limited to these elements, and other elements useful in lighting systems (e.g., reflectors, diffusers, light conduits, etc.) may also be included.

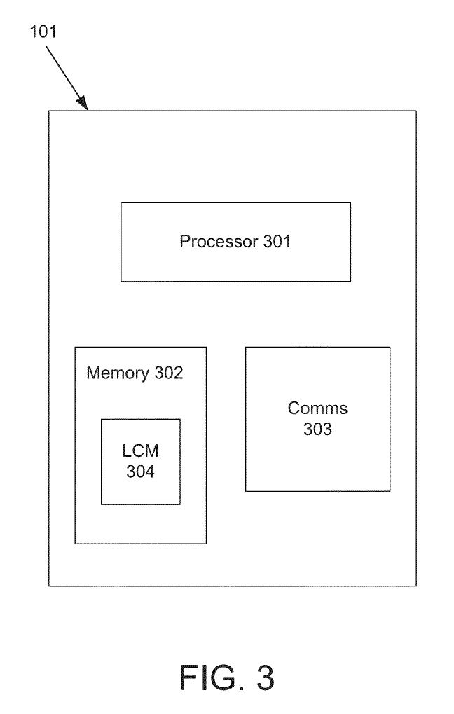

Controller 101 may be any suitable lighting controller, and may be integral with or separate from the light sources and/or drivers described herein. In any case, controller 101 may be any controller including suitable processing, memory, and communication resources to perform the controller operations described herein. In this regard, reference is made to FIG. 3, which depicts an exemplary controller consistent with the present disclosure. As shown, controller 101 may include processor 301, memory 302, and communications interface (Comms) 303.

Processor 301 may be any suitable type of processor, such as a general purpose processor, a desktop processor, a mobile processor, a server processor, an application specific integrated circuit, combinations thereof and the like. In some embodiments, processor 301 is a general purpose processor.

Memory 302 may be any suitable type of computer readable memory. For example, memory 302 may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, memory 302 may include other and/or later-developed types of computer-readable memory. In some embodiments, memory 302 can be local to processor 301 or local to another embedded processor (not shown) within controller 101.

Comms 303 may include hardware (i.e., circuitry), software, or a combination of hardware and software that is configured to allow controller 101 to transmit control signals to one or more light sources (or drivers thereof), and optionally to receive signals (e.g., feedback signals) from one or more sensors. Accordingly, Comms 303 may be configured to permit transmission and/or receipt of signals using wired and/or wired communications, e.g., with a predetermined communications protocol. Comms 303 may therefore include hardware to support such communication, e.g., one or more transponders, antennas, BLUETOOTH™ chips, WiFi chips, personal area network chips, near field communication chips, combinations thereof, and the like.

Controller 101 may include lighting control module (LCM) 304, as shown in FIG. 3. For the sake of illustration, LCM 304 is illustrated as being stored on memory 302. It should be understood that such illustration is exemplary, and LCM 304 may be provisioned in another memory or as a standalone module. In any case, LCM 304 may include computer readable instructions which when executed by a processor (e.g., processor 301) cause controller 101 to perform lighting control operations consistent with the present disclosure.

Returning to FIG. 1A, first and second light sources 103, 104 may be any suitable light source, such as but not limited to a single mode or multimode light source. Accordingly, first and second light sources 103, 104 may be the same or different type of single and/or multimode source. In some embodiments first and second light sources 103, 104 are the same type of source, such as a single mode or multimode LED, incandescent lamp, fluorescent lamp, and/or high intensity discharge (HID) lamp. In other embodiments, first and second light sources 103, 104 are different types of sources. E.g., first light source 103 may be a first type of single mode source, whereas second light source 104 may be a second type of single mode source or a multimode source. Without limitation, light sources 103, 104 are preferably single mode sources, such as single mode LED, single mode fluorescent, or single mode HID lamp. In other embodiments, light sources 103, 104 are both multimode sources.

Regardless of their type, first light source 103 and second light source 104 are preferably configured such that they respectively output light of a first color temperature and a second color temperature, wherein the first and second color temperatures differ from one another. The first and second color temperatures may be any suitable color temperature, so long as they are different. For example, the first and second color temperatures may be within the range of about 1000 Kelvin (K) to about 10,000K or more. Without limitation, the first and second color temperatures are preferably within the range of about 2000K to about 7000K, such as about 2500K to about 6500K. In some embodiments, the first color temperature is about 2700K, and the second color temperature is about 6500K. Of course, such color temperatures and ranges are exemplary, and first and second light sources 103, 104 may each be configured to output light of any desired color temperature. Moreover, it should be understood that in instances whereas multimode source is used as one or both of first and second light sources 103, 104, such sources may be capable of producing output light at a variety of color temperatures.

First and second light sources 103, 104 may also be configured such that the intensity of their respective light outputs may be varied. In this regard, first and second light sources 103, 104 may be driven by one or more drivers. This concept is illustrated in FIG. 1A, wherein first and second light sources 103, 104 are both coupled to and driven by driver 102. Driver 102 may be any suitable lighting driver that is capable of independently driving multiple light sources to different intensities. The manner in which driver 102 drives such light sources to different intensities is not limited, and any suitable mechanism may be used. For example, driver 102 may be configured to independently drive first and second light sources 103, 104 to different intensities, e.g., by adjusting an amount of forward current sent to each light source, via pulse width modulation, another method of controlling intensity of a light source, or a combination thereof.

Driver 102 may independently drive first and second light sources 103, 104 to different intensities in response to the receipt of one of or more control signals, e.g., from controller 101. In this regard, driver 102 may in some embodiments may be configured to convert control parameters in said control signals to one or more driving signals that are configured to drive first and second light sources 103, 104 to different intensities. In such instances driver 102 may be calibrated (e.g., during production or at another time) to convert input control signals from controller 101 to driving signals that cause first and second light sources 103, 104 to produce a combined light output with a desired target color temperature. In some embodiments, first and second light sources 103, 104 are single and/or multimode LED sources, and driver 102 is an appropriate LED driver that is capable of driving such sources to different intensities.

Driver 102 may also be configured to drive one or more light sources to a variety of colors and/or color temperatures, e.g., in response to receiving a control signal from controller 101. For example when at least one of first light source 103 and second light source 104 is a multimode source, driver 102 may be configured to drive the multimode source(s) to a desired color, color temperature, and/or intensity in response to a control signal from controller 102.

In any case, driver 102 may be configured to drive first and second light sources 103, 104 independently of each other. That is, driver 102 may be configured such that it may drive first light source 103 to a first intensity and/or first color temperature, while synchronously or asynchronously driving second light source 104 to a second, different intensity and/or second color temperature, and vice versa. Therefore in instances where first light source 103 is a multimode source and second light source 104 is a single mode source, driver 102 may drive first light source 103 to a first intensity and/or first color temperature, while synchronously or asynchronously driving second light source 104 to a second, different intensity. In instances where first and second light sources 103, 104 are both multimode sources, driver 102 may drive first light source 103 to a first intensity and/or first color temperature, while synchronously or asynchronously driving second light source 104 to a second, different intensity and/or second color temperature.

The configuration shown in FIG. 1A is of course exemplary, and it should be understood that it is not necessary to use a single driver to drive multiple light sources. Indeed in some embodiments, each light source in a system may be coupled or otherwise equipped with a driver that is capable of driving its intensity and/or color temperature. This concept is illustrated in FIG. 1B, which illustrates a system 100′ that is identical to system 100, except that first and second light sources 103, 104 are respectively driven by drivers 102′ and driver 102″. It should be understood that drivers 102′ and 102″ may be the same or different, and may vary based on the type of light source used as first and second light sources 103, 104. Otherwise, the operation of drivers 102′, 102″ is essentially the same as that of driver 102, except insofar as such drivers are responsible for driving a single light source to which they are coupled. In such embodiments, controller 101 may be configured to selectively output control signals to drivers 102′, 102″, so as to independently control the intensity and/or color temperature of first and second light sources 103, 104.

Alternatively, controller may send the same control signal to drivers 102′, 102″. In such instances, the control signal may include first and second control parameters (e.g., brightness, color temperature, etc.) for first light source 103 and second light source 104, respectively. In such instances the control signal may include light source identification information, which may function to attribute the first control parameters to first light source 103, and the second control parameters 104. Drivers 102′, 102″ may be configured to analyze a control signal from controller 101 for light source identification information to identify appropriate control parameters for their respective light sources. Once appropriate control parameters are identified, drivers 102′, 102′ may convert such parameters into appropriate driving signals to drive first and second light sources, respectively, to an appropriate intensity and/or color temperature.

As noted previously, first and second light sources 103, 104 may respectively output light of a first color temperature and a second color temperature, but with variable intensity. With this in mind, controller 101 may communicate control signals to driver 102 (FIG. 1A) or drivers 102′ and 102″ (FIG. 1B) that may cause such driver(s) to independently drive first light source 103 to a first intensity and second light source 104 to a second intensity, as generally discussed above. In this way, controller 101 may independently control the intensity of first and second light sources 103, 104.

While FIGS. 1A-2B illustrate embodiments wherein a controller and at least one separate driver is used, it should be understood that the illustrated configurations are exemplary only. Indeed, the present disclosure envisions embodiments wherein controller 101 may itself act as a driver of one or more light sources, such as first and second light sources 103, 104. In such instances, controller 101 may be understood as including an integral driver for driving light sources under its control. Thus for example, controller 101 may be configured to determine control parameters for each of first and second light sources 103, 104, and to convert such control parameters to appropriate signals for driving such sources. Controller 101 may then transmit such driving signals to first and second light sources 103, 104 directly (e.g., without receipt by an intervening driver), so as to independently drive such sources to respective first and second intensities and/or color temperatures. In other words, controller 101 may be configured to perform the functions of drivers 102, 102′, and/or 102″, thus eliminating the need for such drivers.

By independently controlling the intensity of first and second light sources 103, 104, controller 101 may adjust the color temperature of the combined light output produced by such sources, even if one or both of them is a single mode source. That is by independently controlling the intensity of first and second light sources 103, 104, controller 101 may cause such sources to collectively produce a combined light output with a color temperature that is between the color temperature of the light output of first light source 103 and the color temperature of light output of second light source 104, as generally described above.

The ability of controller 101 to operate in this manner is based on the recognition that the color temperature of the combined light output from multiple light sources is impacted by the relative intensity of such sources. That is, if first and second light sources respectively produce light having a first and second color temperature, the color temperature of their combined light output will be impacted by the intensity of the first source relative to the second source, and vice versa. Therefore, increasing the intensity of the first source relative to the second will result in a combined light output with a color temperature shifted toward the color temperature of the first source. Similarly, reducing the intensity of the first source relative to the second will shift the color temperature of the combined light output toward the color temperature of the second source.

By way of example, first light source 103 may be configured to output light with a first color temperature of 2700K, and second light source 104 may be configured to output light with a second color temperature of 6500K. Controller 101 may control the intensity of first and second light sources 103, 104 relative to one another, such that their combined light output has a third color temperature ranging from about 2700K to about 6500K. As previously noted, the value of the third color temperature may vary based on the relative intensity of the first and second light sources. If first and second light sources 103, 104 are the same type of source and are capable of emitting light with the same intensity, the value of the third color temperature may correlate to an average of the color temperature of first and second light sources 103, 104, weighted by their intensity.

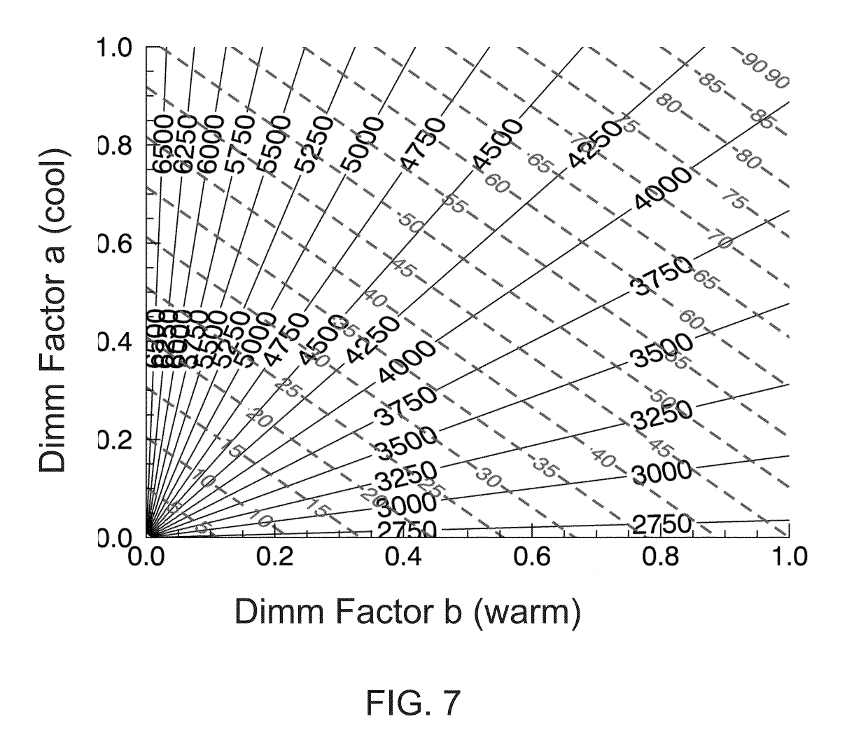

This concept is illustrated in FIG. 7, which plots the color temperature of a combined light output produced by two light sources, a and b, as a function of the degree to which they are dimmed (dim factor) relative to one another, i.e., their relative intensity. Light source a is a single mode source producing a light output with a relatively cool correlated color temperature, and light source b is a single mode source producing a light output with a relatively warm correlated color temperature. The plot in FIG. 7 was produced by converting the color coordinates of sources a and b into values of a color coordinate system, X, Y, Z. Mixing of the light output from the sources was performed additively and the total lumen value derived. From the mixed value, the correlated color temperature was calculated using McCamy's formula.

Controller 101 in some embodiments is configured to leverage this principal to independently control the intensity of multiple light sources, such that the combined light output of such sources exhibits a desired (target) color temperature. For example, controller 101 may output control signals that control the intensity of the light output from first and second light sources 103, 104, such that the color temperature of the combined light output from such sources is substantially equal to a target color temperature. As will be discussed later, the control signals output from controller 101 may include control parameters for at least one of first and second light sources 103, 104, wherein the control parameters are determined at least in part on a time component, such as a time of day and/or time step correlating to a time of day.

Controller may determine control parameters for the first and second light sources, based at least in part on one or more time dependent representations of lighting characteristics (e.g., intensity, color temperature, etc.) as a function of time. As will be discussed later, such representations may be developed from data obtained by the measurement of natural lighting conditions, e.g. occurring at or proximate to a space to be illuminated. Alternatively such representations may be determined from artificial lighting data specified for the space, e.g., by a lighting designer. In any case, it may be understood that controller 101 may select and/or calculate control parameters for first and second light sources 103, 104 based at least in part on a time component, such as a time of day or a time step correlating to a time of day.

Any suitable parameters may be used as control parameters, provided that they may be leveraged to independently control the intensity and/or color temperature of multiple light sources. Non limiting examples of such parameters include intensity, color temperature, other information, and combinations thereof. In instances where controller 101 also acts as a driver, the control parameters may include electrical parameters (current, voltage, etc.) for driving first and second light sources 103, 104. Without limitation, control signals from controller 101 preferably include a combination of intensity and color temperature at a particular time, and/or electrical parameters corresponding to such intensity and color temperature.

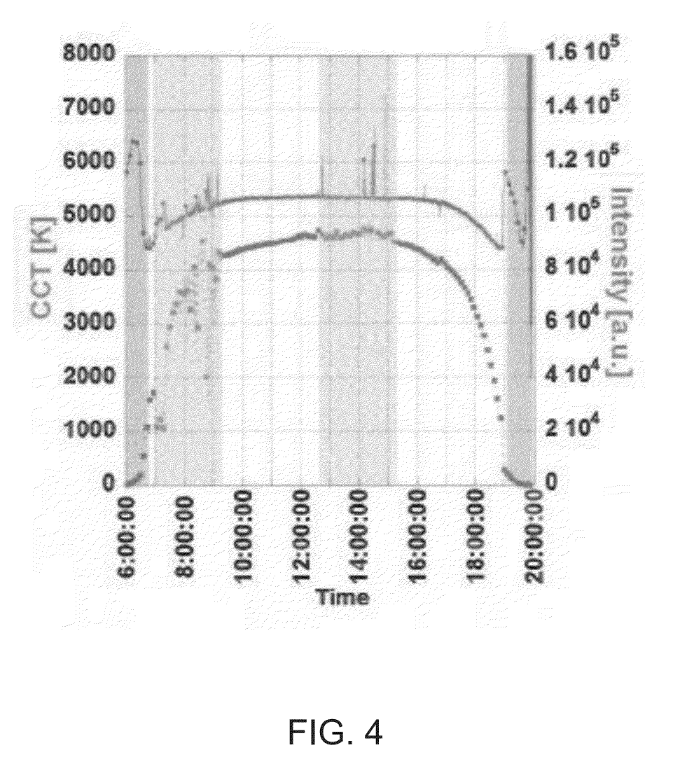

As will be discussed in detail later in connection with FIGS. 4-6, controller 101 may determine such control parameters from a representation of lighting characteristics as a function of time. In some embodiments, controller 101 may determine the control parameters on the fly using the representation of lighting conditions. Alternatively or additionally, a set of control parameters as a function of time may be predetermined and stored in a memory of controller 101, e.g., in association with one or more lighting profiles. In either case, controller 101 may determine control parameters for use in independently controlling the intensity and/or color temperature of first and second light sources 103, 104 based at least in part on a time of day and/or time step correlating to a time of day. One or more of the control parameters may be or may correlate to a target lighting characteristic, such as a target color temperature for the space to be illuminated of a space to be illuminated at a particular time, such as a particular time of day and/or time step. For example, a color temperature determined by a controller at a particular time (e.g., time of day/time step) may correlate to a target color temperature for the combined light output from the light sources under the purview of the controller.

Once controller 101 has determined (e.g., by calculation and/or selection) which control parameters are to be used, it may then output control signals containing such control parameters to first and second light sources 103, 104. Such control parameters may cause the first and second light sources to produce light at respective first and second intensities (and/or color temperatures), such that their combined light output exhibits a target lighting characteristic associated with the control parameters, e.g., a color temperature at a particular time.

For example, first and second light sources 103, 104 may be configured to output light with a first color temperature of 2500K and a second color temperature of 6000K, respectively. With this in mind, controller 101 may be configured to execute a lighting profile specifying a target color temperature for a space to be illuminated as a function of time (e.g., time of day and time step). In such instance, controller 101 may determine control parameters for controlling the intensity and/or color temperature of first and second light sources 103, 104 based at least in part on a time component, such as a particular (e.g., first) time of day and/or a time step correlated to a time of day. Controller 101 may then transmit control signals containing the determined control parameters to first and second light sources 103, 104 (or respective drivers thereof). Such control signals may independently drive first and second light sources 103, 104 to respective first and second intensities, such that they collectively produce a combined light output with a third color temperature (e.g., 4500K) between the first (2500K) and second (6000K) color temperatures, wherein the third color temperature corresponds to the target color temperature.

Control signals from controller 101 may be in any suitable format, such as the DMX and/or DALI formats commonly used in lighting applications. Without limitation, the control signals are preferably in a format that may be understood by the drivers of the relevant light sources, e.g., drivers 102, 102′, and 102″. In this regard, controller 101 may transmit control signals using any suitable form of communication. Non-limiting examples of suitable communication forms that may be used include wired communication (e.g., via a direct wired communications link such as a telephony link, cable link, ethernet link, combinations thereof, and the like) and wireless communication (e.g., via a cellular network, a WiFi network, BLUETOOTH® communication, near field communication (NFC), radio frequency identification (RFID), a ZigBee network, combinations thereof, and the like). Without limitation, controller 101 preferably communicates with driver(s) 102, 102′, 102″ (or light sources 103, 104) via one or more signal wires/traces and/or via a wireless communications link such as WiFi, BLUETOOTH® or NFC. Of course, drivers 102, 102′, and 102″ (when used) may be configured to receive control signals from controller 101 via a communications link/protocol that is compatible with the communications capabilities of controller 101.

While the discussion of FIGS. 1A and 1B above focuses on the use of single mode sources, one or both of first and second light sources 103, 104 may be a multimode source, as mentioned above. In such instances, controller 101 may be configured to not only control the intensity of first and second light sources 103, 104, but also their color temperature (where possible). Controller 101 may use this capability to drive first and second light sources such that they produce a combined light output with a desired color temperature. As may be appreciated, the use of a multimode light source may add flexibility to the control scheme, e.g., by permitting the production of a combined light output with a wider range of color temperatures.

As further shown in FIGS. 1A-2B, the lighting systems described herein may optionally include mixing chamber 105. In general, mixing chamber 105 may function to facilitate the mixing of light produced by first and second light sources 103, 104, respectively. In this regard, mixing chamber 105 may include one or more reflectors or other optical components that facilitate the intermixing of the respectively light outputs from first and second light sources 103, 104. The resulting mixed light (e.g. combined light output) may then be directed from mixing chamber to a space to be illuminated, either directly or after passage through other components such as a diffuser (not shown). This can give the impression that the light output from light sources 103, 104 originated from the same source.

The lighting systems described herein may optionally further include an ambient sensor. This concept is shown in FIGS. 2A and 2B, which are identical to FIGS. 1A and 1B except insofar as they illustrate systems 200, 200′ as including ambient sensor 210. In general, ambient sensor 210 may function to measure the actual lighting conditions of a space that is illuminated by the lighting systems described herein, such as systems 200, 200′. Based on those measurements, ambient sensor may communicate feedback signals containing information about such lighting conditions to controller 101. Such feedback signals may contain information about a target lighting characteristic associated with the control parameters determined by controller 101, such as color temperature.

Controller 101 may use information in feedback signals received from ambient sensor 210 to determine whether actual lighting condition of the space exhibits the target lighting characteristic. If not, controller 101 may adjust the control parameters in its control signals to alter the light output produced by first and second light sources 103, 104 until the feedback signals indicate that the target lighting characteristic has been substantially achieved. For example, controller 101 may compare color temperature information in a feedback signals to determine whether the actual lighting condition of an illuminated space exhibits a target color temperature. If not, controller 101 may adjust the control parameters included in its control signals, e.g., to adjust the intensity and/or color temperature of the light output of first and second light sources 103 and 104, until the feedback signals indicate that the target color temperature is substantially achieved.

Another aspect of the present disclosure relates to methods of configuring a lighting controller, as well as methods of using such controllers to control multiple light sources. In this regard, it is again noted that it by independently controlling the intensity of multiple light sources relative to one another, it is possible to obtain a combined light output with a variety of color temperatures. As described below, the controllers of the present disclosure may be configured to take advantage of this principle by determining control parameters for at least one of a first and second light source, based at least in part on a time dependent representation of lighting characteristics for an environment to be illuminated by the system.

As used herein, the phrase “time dependent representation of lighting characteristics” refers to any mechanism in which lighting characteristics for an environment may be represented as a function of time. Non-limiting examples of such representations include mathematical algorithms that correlate or otherwise specify one or more lighting characteristics (e.g., intensity, color temperature) of a space as a function of time, databases (e.g., look up tables, etc.) specifying lighting characteristics at specified times, combinations thereof, and the like. Such time dependent representations of lighting characteristics may be determined from actual lighting measurements (e.g., lighting measurements taken over a specified time period at a location to be illuminated) or from artificial lighting data, e.g., specified by a lighting engineer or another user of the systems described herein.

Once a time dependent representation of a lighting characteristic has been set, the controllers described herein may be configured to use such representation to determine control parameters for multiple light sources, based on a time of day. In this way, a controller consistent with the present disclosure may determine control parameters for the light sources under its control, so as to cause such sources to collective produce a combined light output with a target lighting characteristic, such as a target color temperature. If necessary, an adjustment factor may be determined and applied to account for variations in the length of a day, e.g., due to a geographic location of the space to be illuminated, and/or a time of year.

For the purpose of clarity, the present disclosure will now proceed to describe an example wherein intensity and color temperature measurements are used to produce a time dependent representation of lighting characteristics for a space to be illuminated. A controller consistent with the present disclosure is then configured to utilize the time dependent representation to determine control parameters for driving multiple light sources under its control to achieve a target lighting characteristic, in this case color temperature.

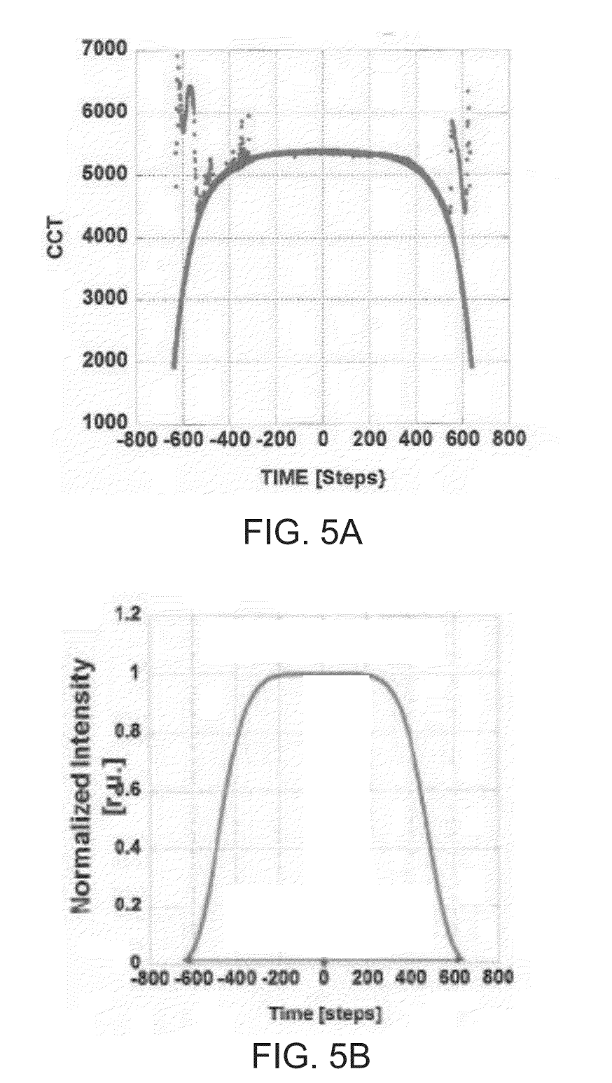

Reference is therefore made to FIGS. 4-5B. FIG. 4 depicts, as a function of time, CCT (top curve) and intensity values that were measured from the roof of a building during a “sunny day.” The measurements were performed using a wireless red-green-blue (RGB) sensor system including a type TAOS 3414 sensor). In FIG. 4, shading is used to illustrate times when the sun was below the horizon, or when clouds were passing by.

In this example, the measured values were normalized by dividing the day length into a plurality of time steps and mapping the measured data to the time steps. This is generally shown in FIGS. 5A and 5B, which illustrate examples in which the day length was parsed into 1600 time steps (−800 to +800) correlating to a time of day, and the measured data was mapped to such time steps. It should be understood that the illustrated number of time steps is exemplary, and that more or less time steps may be used. As will be described below, normalizing the data to time steps may facilitate various options for adjusting the control parameters determined by the controllers of the present disclosure, e.g., to account for day length variations. It should be understood however that normalization to time steps is not required, and the principals of the present disclosure may be carried out using any time unit such as hours, minutes, seconds, etc. In any case, the time units utilized may each correlate to a time of day, either in the real world or as specified in a lighting profile.

Moving on, a time dependent representation of the normalized color temperature and intensity data in FIGS. 5A and 5B was produced by mathematically fitting the data using functions that may implemented by a lighting controller consistent with the present disclosure. Specifically, the normalized data of FIG. 5A was fit using equation (I) below, and the normalized data of FIG. 5B was fit using equation (II) below:

CCT(tₛ)=a[CCTₘₐₓ/a+1−exp(b*tₛ²)] (I)

I(tₛ)=Iₘₐₓ*exp[−(c*tₛ)⁶] (II)

In equation (I), CCT(tₛ) is the correlated color temperature (CCT) at time step tₛ, a and b are constant fit parameters, and CCTₘₐₓ is the maximum CCT value measured during the day. In equation (II), I(tₛ) is the intensity at time step tₛ, c is a fit constant, and Iₘₐₓ is the maximum intensity measured during the day.

Using equations (I) and (II) (or another time dependent mathematical representation of CCT and intensity), it is possible to calculate a CCT and intensity values simply by inserting a relevant time step (e.g., corresponding to a time of day). Provided the equations are accurate (i.e., the fit between a curve defined by such equations and the actual measured data is good), such calculations will yield CCT and intensity values that substantially approximate the CCT and intensity values measured by the system at the corresponding time step. As may be appreciated, time dependent representations of other lighting characteristics may also be developed, such that the value of a lighting characteristic may be back calculated by the insertion of a time element, in this case a value of time step tₛ in equations (I) and (II). The controllers described herein may use the results of those calculations (e.g., calculated lighting parameters) as control parameters for driving multiple light sources, as discussed above.

For example, a controller consistent with the present disclosure may be include a lighting control module (LCM) that is configured to determine control parameters for multiple light sources based at least in part on a time dependent representation of lighting characteristics. Such representation may be a mathematical relationship derived from real or artificial light data as explained above. Alternatively, the representation may be the result of such a mathematical relationship calculated over a set period of time and/or time steps.

In the former case, the LCM may cause the controller to determine control parameters on the fly, e.g., by calculating such control parameter from a time dependent mathematical relationships through the use of a time component, such as the time or day (or relevant time step) at the time the LCM is executed. More specifically, the LCM may at the time of its execution cause the controller to determine a time of day, convert the time of day to a corresponding time step (if necessary), and then utilize the time of day and/or time step to calculate CCT and intensity values by inserting the time of day and/or time step into the mathematical time dependent representation. The LCM may then cause the controller to utilize the calculated intensity and/or CCT values as control parameters for driving multiple light sources, as discussed above. In some embodiments, the calculated CCT value may also correspond to a target color temperature for a combined light output collectively produced by the light sources under the purview of the controller.

In the latter case, the controller may be configured to store a database or lookup table in a memory thereof. The database/lookup table may map a plurality of times (e.g., times of day or corresponding time steps) to one or more lighting characteristics (e.g., intensity, color temperature, etc.) that were measured or calculated over a relevant time period (e.g., a minute, day, year, etc. or corresponding time steps). With this in mind, the LCM when executed may cause the controller to determine control parameters from the database/lookup table based at least in part on the use of a time component such as a time of day or corresponding time step, as discussed above.

More specifically, the LCM may cause the controller to determine a time of day at the time of its execution, convert the time of day to a corresponding time step (if necessary), and then utilize the time of day and/or time step to look up lighting characteristics such as CCT and intensity values in the database/lookup table. The LCM may then cause the controller to use those intensity and/or CCT values as control parameters for driving multiple light sources, as discussed above. In some embodiments, the CCT value identified in the lookup table at a particular time period may also correspond to a target color temperature for a combined light output collectively produced by the light sources under the purview of the controller.

The controllers described herein may be configured to determine a time component at a time of execution in any suitable manner. For example, the controllers described herein may include or be coupled to a global positioning or other geo locating sensor. Such sensor may provide location information such as longitude, latitude, etc. to the control module, either alone or in combination with time information. Alternatively or additionally, the controllers described herein may receive time information from one or more integral or external sources of time. Non-limiting examples of such sources include a real time chips that are configured to provide accurate time information to the controller. Alternatively, the controller may receive information from a trusted source of time (e.g., the U.S. Naval Observatory, the National Institute of Science and Technology, etc.) via a wired or wireless communication link, such as via the internet.

Once the controller has determined the time, it may use the time to determine control parameters for multiple light sources under its control using a time dependent representation of lighting characteristics, as discussed above. In instances where such representations are dependent on real time units (e.g., hours and minutes), the controllers described herein may calculate or look up control parameters using the determined real time. In instances where the representations are based on data that has been normalized to an arbitrary unit such as a time step, the controllers may be configured to convert the determined real time to an appropriate time step, and use the time step to calculate or look up the relevant control parameters, as discussed above.

During the course of a year, the length of daylight changes continuously. To account for changes in day length, the controllers of the present disclosure may be configured to calculate an adjustment value which may be applied to a time step determined in the manned discussed above. Ion some embodiments, the adjustment value may increase or decrease the value of the time step, so as to account for variations in the length of a day. Alternatively or additionally, the adjustment value may increase or decrease the length of a time step, so as to account for day length variations. Similarly, adjustment factors may be applied to adjust the position or length of a time step to account for variations in day length resulting from the geographic location of a space to be illuminated.

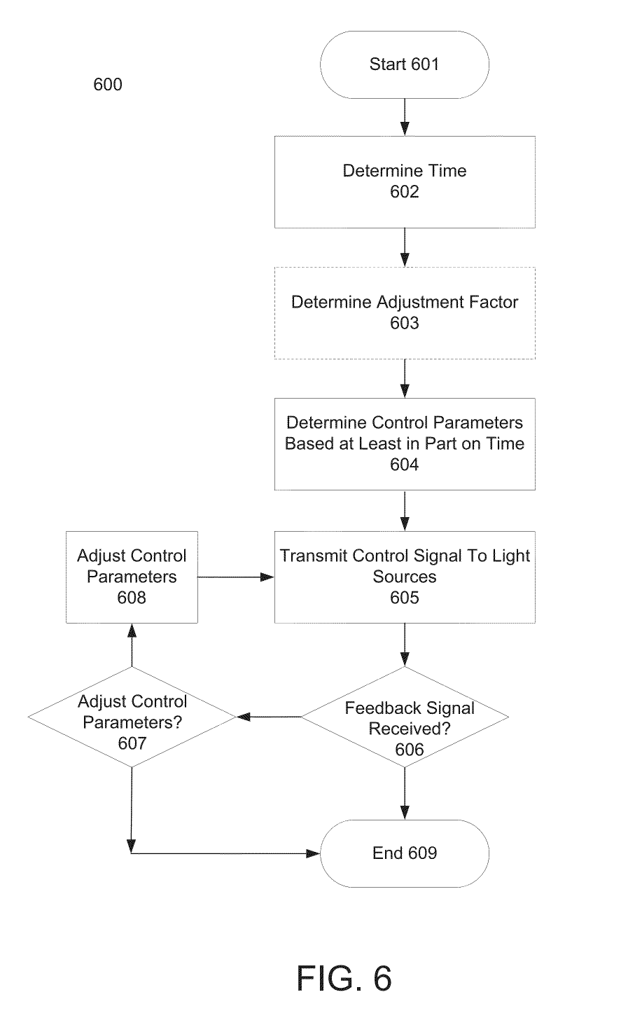

Reference is now made to FIG. 6, which depicts an exemplary method of controlling multiple light sources. As shown, method 600 begins at block 601. At block 602, a controller consistent with the present disclosure may determine the time to be used to determine control parameters, as generally discussed above. The controller may determine the time using any suitable method, as discussed above. Without limitation, the time is preferably determined from signals received from a trusted source of time, such as a real time chip. If necessary, the controller may convert the time into a time step, e.g., in instances where a time dependent representation is derived from data that has been normalized to a plurality of time steps, as discussed above.

Regardless of how the time is determined, the method may proceed to optional block 603, wherein the controller may optionally determine an adjustment factor to be applied to the determined time. If an adjustment factor is to be applied, the controller may apply it to adjust the determined time and account for variations in day length, as discussed above.

Regardless of whether an adjustment factor is applied, the method may proceed to block 604, wherein the controller may determine control parameters for controlling the intensity of first and second light sources based at least in part on the determined time. As discussed above, the controller may perform this function by inputting the determining time (optionally as adjusted by an adjustment factor) into a time dependent mathematical representation of lighting characteristics. Alternatively, the controller may use the determined time (again, optionally adjusted) to look up lighting characteristics that are mapped as a function of time and stored in a database and/or lookup table. The calculated and/or selected lighting characteristics may then be used as control parameters for controlling at least first and second light sources.

The method may then proceed to block 605, wherein the controller may transmit control signals containing the control parameters to at least first and second light sources under its purview. As generally discussed above, the control signals may independently control the intensity first and second light sources and thus, the color temperature combined light output collectively produced by the first and second light sources. More specifically, the control signals may include control parameters that control the intensity of the first and second light sources, so as to drive the color temperature of the combined light output collectively produced by such sources to a target color temperature.

The method may then proceed to block 606, wherein a determination may be made as to whether a feedback signal has been received by the controller, e.g., from one or more ambient sensors. If not (e.g., where no ambient sensor is used), the method may proceed to block 609 and end. If so, the method may proceed to block 607, wherein the controller may determine whether the actual lighting conditions reported by the feedback signal exhibit the target color temperature. If so, it is not necessary to adjust the control parameters and the method may proceed to block 609 and end. If not, the method may proceed to block 608, wherein the controller may adjust the control parameters in an attempt to adjust the color temperature of the combined light output collectively produced by the first and second light sources such that it substantially approximates the target color temperature. Once the feedback signal indicates that the actual lighting conditions exhibit the target color temperature, the method may proceed to block 609 and end.

As may be appreciated from the foregoing, the technologies of the present disclosure may enable a relatively simple control scheme that can be used to obtain a combined light output from multiple independently addressed single or multimode mode light sources, wherein the combined light output produced by such sources has a color temperature between the light output of each of the participating light sources.

What is claimed is:

1. A method of controlling a plurality of light sources including at least a first light source and a second light source, comprising:
with a controller, independently controlling a first intensity of a first light output of said first light source and a second intensity of a second light output of said second light source based at least in part on a first time of day, said first light output having a first color temperature and said second light output having a second color temperature;
wherein independently controlling said first and second intensities causes said plurality of light sources to collectively produce a combined light output exhibiting a target color temperature correlating to said first time of day, the target color temperature ranging from greater than or equal to said first color temperature to less than or equal to said second color temperature.

2. The method of claim 1, wherein independently controlling said first and second intensities comprises:
determining said first time of day;
with said controller, determining control parameters for at least one of said first and second light sources based at least in part on said first time of day and a time dependent representation of light intensity for a space to be illuminated with said first and second light sources, and
transmitting a control signal comprising said control parameters from said controller to at least one of said first light source and said second light source.

3. The method of claim 2, wherein said control parameters comprise color temperature and intensity values corresponding to said first time of day, said color temperature.

4. The method of claim 3, wherein said control signal further comprises first and second current values for said first and second light sources, respectively, said first current value operative to cause said first light source to produce said first light output with a first intensity value, said second current value operative to cause said second light source to produce said second light output with a second intensity value, wherein said first and second intensity values result in the production of said combined light output with said target color temperature.

5. The method of claim 3, wherein at least one driver drives said first and second light sources, and said control signals are configured to cause said at least one driver to drive said first light source to produce said first light output with a first intensity value and to drive said second light source to produce said second light output with a second intensity value, wherein said first and second intensity values result in the production of said combined light output with said target color temperature.

6. The method of claim 3, further comprising:
with said controller, adjusting said control parameters to account for a time of year, thereby producing adjusted control parameters; and
transmitting said adjusted control parameters from said controller to said first light source and said second light source in said control signal.

7. The method of claim 3, further comprising:
receiving a feedback signal from an ambient sensor with said control unit, said feedback signal comprising information regarding an actual lighting condition of a space to be illuminated by said plurality of light sources;
with said controller, determining whether the actual lighting condition of said space exhibits said third color temperature; and
if said actual lighting condition does not exhibit said lighting characteristic, adjusting said control parameters with said control unit so as to alter at least one of said first and second light outputs, such that the actual lighting condition of said space to be illuminated exhibits said lighting characteristic.

8. The method of claim 3, wherein said controller comprises a memory having a database stored thereon, the database mapping a plurality of correlated color temperature and intensity values to a plurality of times of day, said plurality of times of day including said first time of day, and determining said control parameters comprises:
with said controller, selecting said first correlated color temperature and first intensity values from said database based at least in part on said first time of day.

9. The method of claim 3, wherein determining said control parameters comprises:
with said controller, calculating said first correlated color temperature and first intensity values based at least in part on said first time of day.

10. The method of claim 1, wherein said first light source is a multimode source, the method further comprising:
with said controller, controlling a first color temperature of said first light source based at least in part on said time of day, so as to cause said plurality of light sources to collectively produce said combined light output.

11. The method of claim 1, wherein said first and second light sources are multimode sources, the method further comprising:
with said controller, controlling said first color temperature of said first light source and said second color temperature of said light source based at least in part on said first time of day, so as to cause said plurality of light sources to collectively produce said combined light output.

12. The method of claim 1, wherein said first and second light sources are both single mode sources.

13. A lighting controller for a plurality of light sources including at least a first light source and a second light source, the controller comprising a processor and a memory having computer readable lighting control module (LCM) instructions stored thereon, wherein said LCM instructions when executed by said processor cause said lighting controller to perform the following operations comprising:
independently controlling a first intensity of a first light output of said first light source and a second intensity of a second light output of said second light source based at least in part on a first time of day, said first light output having a first color temperature and said second light output having a second color temperature;
wherein independently controlling said first and second intensities causes said plurality of light sources to collectively produce a combined light output exhibiting a third color temperature correlated to said first time of day, the third color temperature ranging from greater than or equal to said first color temperature to less than or equal to said second color temperature.

14. The lighting controller of claim 13, wherein independently controlling said first and second intensities comprises:
transmitting a control signal from said controller to said first light source and said second light source, said control signal comprising control parameters based at least in part on said first time of day.

15. The lighting controller of claim 14, wherein said control parameters comprise first correlated color temperature and intensity values corresponding to said first time of day.

16. The lighting controller of claim 15, wherein said control signal further comprises first and second current values for said first and second light sources, respectively, said first current value operative to cause said first light source to produce said first light output with a first intensity value, said second current value operative to cause said second light source to produce said second light output with a second intensity value, wherein said first and second intensity values result in the production of said combined light output.

17. The lighting controller of claim 15, wherein at least one driver drives said first and second light sources, and said control signals are configured to cause said at least one drive r to drive said first light source to produce said first light output with a first intensity value and to drive said second light source to produce said second light output with a second intensity value, wherein said first and second intensity values result in the production of said combined light output.

18. The lighting controller of claim 15, wherein said LCM instructions when executed further cause said controller to perform the following operations comprising:
adjusting said control parameters to account for a time of year, thereby producing adjusted control parameters; and
transmitting said adjusted control parameters to said first light source and said second light source in said control signal.

19. The lighting controller of claim 15, wherein said LCM instructions when executed further cause said controller to perform the following operations comprising:
determining, in response to receiving a feedback signal comprising information regarding an actual lighting condition of a space to be illuminated by said plurality of light sources, whether the actual lighting condition of said space exhibits said third color temperature; and
adjusting, if said actual lighting condition does not exhibit said lighting characteristic, said control parameters so as to alter at least one of said first and second light outputs, such that the actual lighting condition of said space to be illuminated exhibits said lighting characteristic.

20. The lighting controller of claim 15, further comprising a database stored in said memory, said database mapping a plurality of correlated color temperature and intensity values to a plurality of times of day, said plurality of times of day including said first time of day, and the LCM instructions when executed further cause the controller to perform the following operations comprising:
selecting said first correlated color temperature and intensity values from said database based at least in part on said first time of day.

21. The lighting controller of claim 15, wherein said LCM instructions when executed further cause said controller to perform the following operations comprising:
calculating said first correlated color temperature and intensity values based at least in part on said time of day.

22. The lighting controller of claim 13, wherein said first light source is a multimode source, and the LCM instructions when executed further cause said controller to perform the following operations comprising:
controlling a first color temperature of said first light source based at least in part on said time of day, so as to cause said plurality of light sources to collectively produce said combined light output.

23. The lighting controller of claim 13, wherein said first and second light sources are multimode sources, and the LCM instructions when executed further cause said controller to perform the following operations comprising:
controlling said first color temperature of said first light source and said second color temperature of said light source based at least in part on said first time of day, so as to cause said plurality of light sources to collectively produce said combined light output.
